(19) United States
(12) Patent Application Publication
(10) Pub. No.: US 2021/0064728 A1
(43) Pub. Date: Mar. 4, 2021

(54) DEVICE SECURITY ENHANCEMENT

(71) Applicant: Qualcomm Incorporated, San Diego, CA (US)

(72) Inventors: Ravi Shankar KADAMBALA, Hyderabad (IN); Soman Ganesh NIKHARA, Hyderabad (IN); Bapineedu Chowdary GUMMADI, Hyderabad (IN); Ankita Anil Kumar CHOUDHA, Hyderabad (IN)

(21) Appl. No.: 16/908,221

(22) Filed: Jun. 22, 2020

(30) Foreign Application Priority Data
Aug. 29, 2019 (IN) 201941034802

(51) Int. Cl. G06F 21/32; H04M 1/725; G06F 3/0481; G06F 3/0484; G06K 9/00

(52) U.S. Cl. CPC G06F 21/32; H04M 1/72577; G06K 9/00295; G06F 3/04842; G06K 9/00087; G06F 3/04817

(57) ABSTRACT

A method and apparatus facilitate securing access to applications. An apparatus includes a touch-sensitive display configured to display a plurality of objects representing a plurality of applications, the touch-sensitive display configured to receive a selection of a first object of the plurality of objects representing a first application of the plurality of applications. The apparatus also includes an authentication module coupled to the display. The authentication module is configured to receive biometric data in response to the selection of the first object, compare the received biometric data to a biometric template, and generate a match signal upon a determination that the received biometric data matches the biometric template. The apparatus also includes a processor configured to prevent access to the first application before the match signal is received, and enable access to the first application in response to the receipt of the match signal.

### CLAIM OF PRIORITY UNDER 35 U.S.C. § 119

The present application for Patent claims Foreign priority to India Application No. 201941034802 entitled “DEVICE SECURITY ENHANCEMENT” filed Aug. 29, 2019, assigned to the assignee hereof and hereby expressly incorporated by reference herein.

### FIELD

The present invention relates to a mobile device that provides biometric authentication to enhance security of a device.

### BACKGROUND

User authentication is commonly required to access a mobile device, such as, a smart phone, a tablet, a laptop computer, etc. Many types of authentication techniques, such as, passwords, fingerprints, voice inputs, etc., are presently utilized. Authentication techniques on mobile devices are typically based upon an explicit request for an explicit authentication input. For example, commonly deployed discrete authentication methods to authenticate a user to a mobile device may be a password or a fingerprint externally inputted by the user.

### SUMMARY

In one aspect, an apparatus includes a touch-sensitive display configured to display a plurality of objects representing a plurality of applications. The touch-sensitive display is configured to receive a selection of a first object of the plurality of objects representing a first application of the plurality of applications. The apparatus also includes an authentication module coupled to the display. The authentication module is configured to receive biometric data in response to the selection of the first object, compare the received biometric data to a biometric template, and generate a match signal upon a determination that the received biometric data matches the biometric template. The apparatus also includes a processor configured to prevent access to the first application before the match signal is received, and enable access to the first application in response to the receipt of the match signal.

In another aspect, a method of securing access to device applications includes displaying a plurality of objects representing a plurality of applications and receiving a selection of a first object of the plurality of objects representing a first application of the plurality of applications. The method also includes receiving biometric data in response to the selection of the first object, comparing the received biometric data to a biometric template, and generating a match signal upon a determination that the received biometric data matches the biometric template. The method also includes preventing access to the first application before the match signal is received, and enabling access to the first application in response to the receipt of the match signal.

In another aspect, an apparatus includes means for displaying a plurality of objects representing a plurality of applications. The means for displaying is configured to receive a selection of a first object of the plurality of objects representing a first application of the plurality of applications. The apparatus also includes means for receiving biometric data in response to the selection of the first object, means for comparing the received biometric data to a biometric template, and means for generating a match signal upon a determination that the received biometric data matches the biometric template. The apparatus also includes means for preventing access to the first application before the match signal is received, and means for enabling access to the first application in response to the receipt of the match signal.

In yet another aspect, a non-transitory storage medium includes processor-executable instructions stored thereon. When a processor executes the instructions, the processor is configured to display a plurality of objects representing a plurality of applications and receive a selection of a first object of the plurality of objects representing a first application of the plurality of applications. The processor is also configured to receive biometric data in response to the selection of the first object, compare the received biometric data to a biometric template, and generate a match signal upon a determination that the received biometric data matches the biometric template. The processor is also configured to prevent access to the first application before the match signal is received, and enable access to the first application in response to the receipt of the match signal.

### BRIEF DESCRIPTION OF THE DRAWINGS

FIG. 1 is a diagram of a device in which aspects of the invention may be practiced.

FIG. 2 is a flowchart illustrating an example of a process for performing biometric authentication in accordance with some examples.

FIG. 3. is a front view of a diagrammatic representation of an example device that includes a fingerprint sensing system according to some implementations.

FIG. 4 is a block diagram representation of components of an example fingerprint sensing system, according to some implementations.

FIG. 5 is a block diagram of an example user interface that may be displayed on a display of the device shown in FIG. 1 or FIG. 3.

FIG. 6. is a flowchart illustrating an example method of securing access to one or more device applications.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the term “mobile device” refers to any form of programmable computer device including but not limited to laptop computers, tablets, smartphones, televisions, desktop computers, home appliances, cellular telephones, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, or any computing device or data processing apparatus.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Systems and techniques are described herein that provide biometric authentication to enhance security of device applications. For example, a person can be authenticated based on one or more templates that are unique to the person. The one or more templates can be referred to as a template set for the person. The templates can be generated during an enrollment step (e.g., during registration). During an authentication step, a similarity can be computed between the one or more templates and input biometric data of a user purporting to be the person. A resulting similarity score can then be used to determine whether the user is the person with a high degree of certainty. A match signal may be generated if the similarity score exceeds a match threshold. The match signal may be used to enable access to one or more secured or “locked” applications on the device.

In some aspects, the biometric data may be fingerprint data, facial data (e.g., a facial image including facial features), voice data, heart rate data, or other suitable forms of biometric data.

Using face identification as an example, an enrolled database containing the features of enrolled faces can be used for comparison with the features of one or more given query face images (e.g., from input images or frames). The enrolled faces can include faces registered with the system and stored in the enrolled database, which contains known faces. An enrolled face that is the most similar to a query face image can be determined to be a match with the query face image. Each enrolled face can be associated with a person identifier that identifies the person to whom the face belongs. The person identifier of the matched enrolled face (the most similar face) is identified as the person to be recognized.

Face authentication, for example, can compare a face of a device user in an input image with known features (e.g., stored in one or more templates) of the person the user claims to be, in order to authenticate that the user of the device is, in fact, the person. A similar process can be performed for fingerprint authentication, voice authentication, and other biometric-based authentication methods.

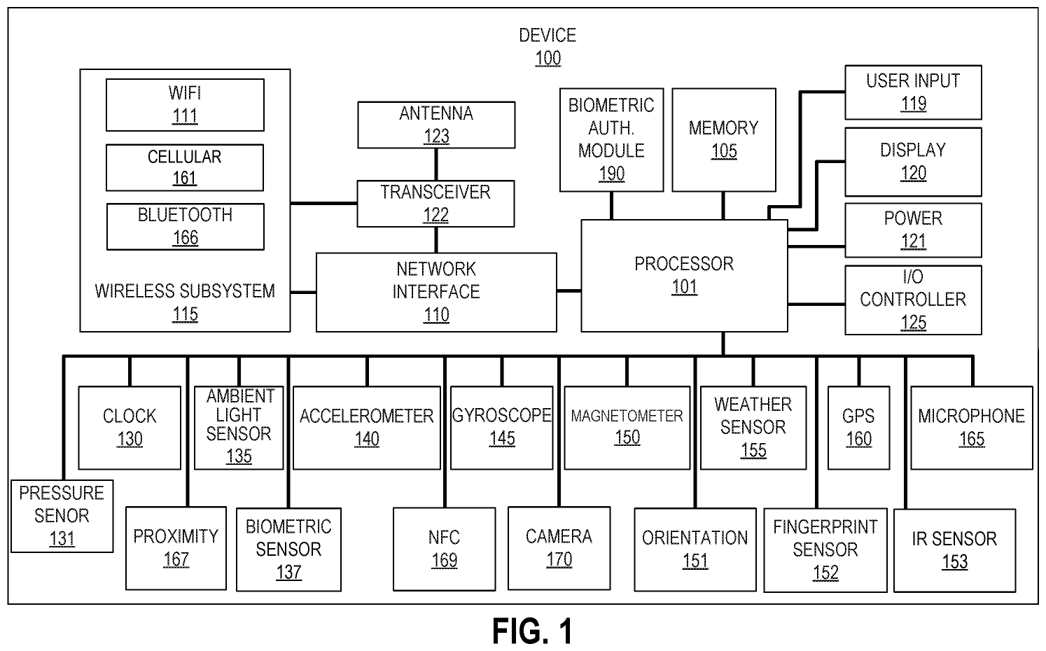

FIG. 1 is block diagram illustrating an exemplary device 100 in which embodiments of the invention may be practiced. The system may be a computing device (e.g., a mobile device 100), which may include one or more processors 101, a memory 105, I/O controller 125, and network interface 110. Mobile device 100 may also include a number of sensors coupled to one or more buses or signal lines further coupled to the processor 101. It should be appreciated that mobile device 100 may also include a display 120 (e.g., a touch screen display), a user interface 119 (e.g., keyboard, touch screen, or similar devices), a power device 121 (e.g., a battery), as well as other components typically associated with electronic devices. In some embodiments, mobile device 100 may be a transportable device, however, it should be appreciated that device 100 may be any type of computing device that is mobile or non-mobile (e.g., fixed at a particular location).

Mobile device 100 may include sensors such as: clock 130, pressure sensor 131, ambient light sensor (ALS) 135, biometric sensor 137 (e.g., EKG, etc.), accelerometer 140, gyroscope 145, magnetometer 150, orientation sensor 151, fingerprint sensor 152, weather sensor 155 (e.g., temperature, wind, humidity, barometric pressure, etc.), Global Positioning Sensor (GPS) 160, infrared (IR) sensor 153, proximity sensor 167, and near field communication (NFC) sensor 169. Further, sensors may include a microphone 165 and camera 170. In one aspect, fingerprint sensor 152 is coupled to display 120 as an under-display fingerprint sensor.

Communication components may include a wireless subsystem 115 (Bluetooth 166, Wi-Fi 111, cellular 161), which may also be considered sensors, that are used to analyze the environment (e.g., position) of the device. In some embodiments, multiple cameras are integrated or accessible to the device. For example, mobile device 100 may have at least a front and rear mounted camera.

Memory 105 may be coupled to processor 101 to store instructions for execution by processor 101. In some embodiments, memory 105 is non-transitory. Memory 105 may store one or more programs, modules, engines, etc., to implement embodiments described below that are implemented by processor 101. Memory 105 may also store data from integrated or external sensors.

Mobile device 100 may include one or more antenna(s) 123 and a transceiver 122. The transceiver 122 may be configured to communicate bi-directionally, via the antenna(s) and/or one or more wired or wireless links, with one or more networks, in cooperation with network interface 110 and wireless subsystems 115. Network interface 110 may be coupled to a number of wireless subsystems 115 (e.g., Bluetooth 166, Wi-Fi 111, Cellular 161, or other networks) to transmit and receive data streams through a wireless link to/from a wireless network, or may be a wired interface for direct connection to networks (e.g., the Internet, Ethernet, or other wireless systems). Mobile device 100 may include one or more local area network transceivers connected to one or more antennas. The local area network transceiver comprises suitable devices, hardware, and/or software for communicating with and/or detecting signals to/from WAPs, and/or directly with other wireless devices within a network. In one aspect, the local area network transceiver may comprise a Wi-Fi (802.11x) communication system suitable for communicating with one or more wireless access points.

Mobile device 100 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, Advanced LTE, WCDMA, UMTS, 4G, 5G, GSM, etc. Additionally, any other type of wireless networking technologies may be used, for example, WiMax (802.16), Ultra Wide Band, ZigBee, wireless USB, etc. In conventional digital cellular networks, position location capability can be provided by various time and/or phase measurement techniques. For example, in CDMA networks, one position determination approach used is Advanced Forward Link Trilateration (AFLT).

Thus, device 100 may be a: mobile device, wireless device, cellular phone, personal digital assistant, mobile computer, wearable device (e.g., head mounted display, wrist watch, virtual reality glasses, etc.), internet appliance, gaming console, digital video recorder, e-reader, robot navigation system, tablet, personal computer, laptop computer, or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, mobile device 100 may include a radio device, a cellular telephone device, a computing device, a personal communication system device, or other like movable wireless communication equipped device, appliance, or machine. The term “mobile device” is also intended to include devices which communicate with a personal navigation device, such as by short-range wireless, infrared, wire line connection, or other connection—regardless of whether satellite signal reception, assistance data reception, and/or position-related processing occurs at the device 100. Also, “mobile device” is intended to include all devices, including wireless communication devices, computers, laptops, etc., which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile device.”

Mobile device 100 may also include an authentication module 190 that may be used to authenticate a user of mobile device 100. Authentication module 190 may be implemented as software code stored within memory 105, dedicated or shared circuitry of device 100, a portion of processor 101 (or a separate processor), or any combination of the foregoing. In one example, authentication module 190 is a biometric authentication module that receives biometric input data from one or more sensors (e.g., camera 170, fingerprint sensor 152, biometric sensor 137, and/or microphone 165). Authentication module 190 may then compare the received biometric input data with one or more templates or other stored data representing previously stored biometric authentication data of the user. If the biometric input data matches the template, authentication module 190 may generate a match signal to unlock one or more features, applications, settings, or the like of mobile device 100. In one example, authentication module 190 is coupled to display 120 to receive touch inputs from display 120 as described more fully herein.

It should be appreciated that embodiments will be hereinafter described that may be implemented through the execution of instructions, for example as stored in the memory 105 or other element, by processor 101 of mobile device 100 and/or other circuitry of device and/or other devices. Particularly, circuitry of the device, including but not limited to processor 101, may operate under the control of a program, routine, or the execution of instructions to execute methods or processes in accordance with embodiments of the invention. For example, such a program may be implemented in firmware or software (e.g. stored in memory 105 and/or other locations) and may be implemented by processors, such as processor 101, and/or other circuitry of device. Further, it should be appreciated that the terms processor, microprocessor, circuitry, controller, etc., may refer to any type of logic or circuitry capable of executing logic, commands, instructions, software, firmware, functionality and the like. The functions of each unit or module within the mobile device 100 may also be implemented, in whole or in part, with instructions embodied in a memory, formatted to be executed by one or more general or application-specific processors.

Various terminologies will be described to aid in the understanding of the embodiments. Sensor inputs may refer to any input from any of the previously described sensors, such as: clock 130, pressure sensor 131, ambient light sensor (ALS) 135, biometric sensor 137 (e.g., EKG, etc.), accelerometer 140, gyroscope 145, magnetometer 150, orientation sensor 151, fingerprint sensor 152, weather sensor 155 (e.g., temperature, wind, humidity, barometric pressure, etc.), Global Positioning Sensor (GPS) 160, infrared (IR) sensor 153, microphone 165, proximity sensor 167, near field communication (NFC) sensor 169, camera 170, etc. Some of the sensors may be utilized for particular authentication techniques which may include: microphone 165 (e.g., voice scan), camera 170 (facial scan), fingerprint sensor 152 (e.g., fingerprint scan), IR sensor 153 (iris scan), etc. It should be appreciated these are just examples and a wide variety of sensors may be used for authentication methods.

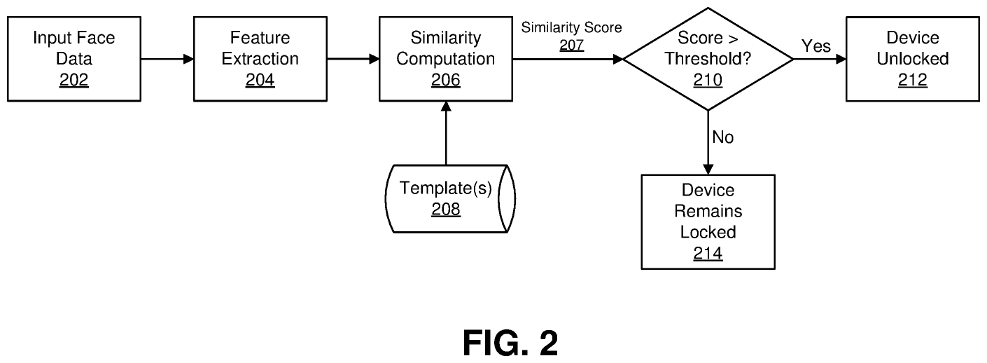

FIG. 2 is a flowchart illustrating an example method 200 of authenticating a user using a face as biometric data. In one example, method 200 may be implemented by authentication module 190. In an example in which authentication module 190 includes software code stored in memory, method 200 may be implemented by processor 101 executing the authentication module 190 to perform the steps of method 200.

In a face recognition process, input face data 202 corresponding to a user attempting to access a device or an application or setting of the device is received. The input face data 202 is processed for feature extraction at block 204. For example, at block 204, a feature representation including one or more features of the face can be extracted from an input image containing the face. The feature representation of the face can be compared to a face representation (e.g., stored as a template in a template database 208 within memory 105) of a person authorized to access the device.

At block 206, a similarity can be computed between the feature representation of the user and a feature representation of the face of the person stored in the template database 208. The computed similarity can be used as the similarity score 207 that will be used to make the final authentication decision. For example, at block 210, the similarity score 207 can be compared to a biometric threshold, such as a face detection or similarity threshold. If the similarity score 207 is greater than the threshold, a match signal may be generated by authentication module 190. The match signal may be transmitted to processor 101 (or may be used by processor 101 if the signal is generated within processor 101). In response to the match signal, processor 101 may unlock device 100 at block 212. However, if the similarity score 107 is not greater than the threshold, no match signal is generated and the device remains locked at block 214. While method 200 is described herein as being used to unlock device 100, method 200 may also or alternatively be used to enable access to a secured or “locked” application, setting, profile, or other portion of device 100. For example, in response to the match signal, processor 101 may enable access to a locked application or setting such that a user may access and/or interact with the application or setting.

In addition, while method 200 is described herein as being used for face recognition, method 200 can be used for any biometric-based authentication, including, but not limited to, fingerprint authentication, voice authentication, or any other type of biometric-based authentication.

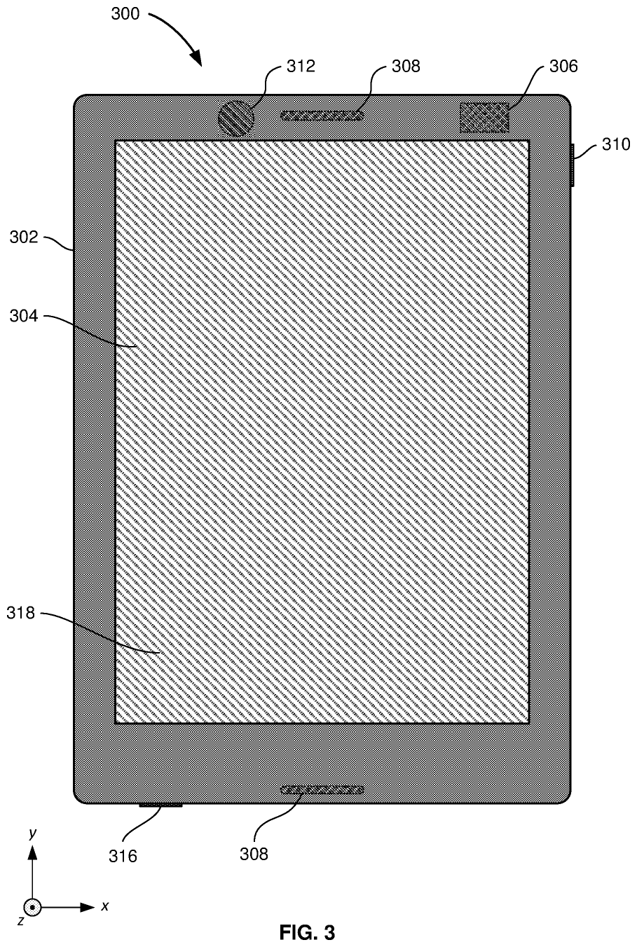

FIG. 3 is a diagrammatic representation of an example mobile device 300 that includes a fingerprint sensing system according to some implementations. In one example, mobile device 300 is an implementation of device 100 shown in FIG. 1 and may include all or a portion of the components and functionality described above with reference to device 100.

Mobile device 300 generally includes an enclosure (also referred to as a “housing” or a “case”) 302 within which various circuits, sensors and other electrical components reside. In the illustrated example implementation, mobile device 300 also includes a touchscreen display (also referred to herein as a “touch-sensitive display”) 304. The touchscreen display 304 generally includes a display and a touchscreen arranged over or otherwise incorporated into or integrated with the display. Display 304 may generally be representative of any of a variety of suitable display types that employ any of a variety of suitable display technologies. For example, display 304 may be a digital micro-shutter (DMS)-based display, a light-emitting diode (LED) display, an organic LED (OLED) display, a liquid crystal display (LCD), an LCD display that uses LEDs as backlights, a plasma display, an interferometric modulator (IMOD)-based display, or another type of display suitable for use in conjunction with touch-sensitive user interface (UI) systems.

Mobile device 300 may include various other devices or components for interacting with or otherwise communicating information to or receiving information from a user. For example, mobile device 300 may include one or more microphones 306, one or more speakers 308, and in some cases one or more at least partially mechanical buttons 310. Mobile device 300 may include various other components enabling additional features such as, for example, one or more video or still-image cameras 312, one or more wireless network interfaces (not shown) (for example, Bluetooth, WiFi or cellular) and one or more non-wireless interfaces 316 (for example, a universal serial bus (USB) interface or an HDMI interface).

Mobile device 300 may include a fingerprint sensing system 318 capable of scanning and imaging an object signature, such as a fingerprint, palm print or handprint. In one embodiment, fingerprint sensing system 318 combines the functionality and/or components of fingerprint sensor 152 and authentication module 190 described in FIG. 1. In some implementations, fingerprint sensing system 318 may function as a touch-sensitive control button. In some implementations, a touch-sensitive control button may be implemented with a mechanical or electrical pressure-sensitive system that is positioned under or otherwise integrated with fingerprint sensing system 318. In other words, in some implementations, a region occupied by fingerprint sensing system 318 may function both as a user input button to control the mobile device 300 as well as a fingerprint sensor to enable security features such as user authentication features. In some implementations, fingerprint sensing system 318 may be positioned under the cover glass of the display or under a portion of the display itself. In some implementations, fingerprint sensing system 318 may be positioned on a sidewall or on the backside of mobile device enclosure 302. Enclosure 302 may house a fingerprint sensor (e.g., fingerprint sensor 152) as part of the fingerprint sensing system 318 that is configurable to operate in either a touch-sensing mode or a fingerprint-sensing mode.

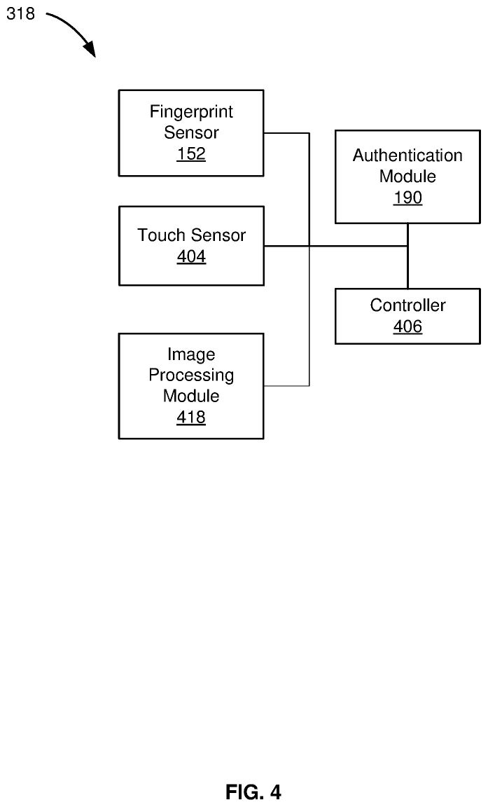

FIG. 4 is a block diagram representation of a fingerprint sensing system 318 for authenticating a fingerprint. A fingerprint sensor 152 is operably connected to a touch sensor 404, an authentication module 190, and a controller 406. Fingerprint sensor 152 and touch sensor 404 may be integrated into a block which performs both the function of fingerprint sensing and touch sensing. Authentication module 190 and controller 406 may be integrated into a block which performs both the function of authentication and control. Authentication module 190 and controller 406 may also be integrated into a general-purpose processor of a device (such as processor 101 of device 100), or in one or more of any processors residing in a device.

Fingerprint sensor 152 may produce an image, or data representative of an image, by any means of capturing and converting a fingerprint into an image or image data. Authentication module 190 may receive a fingerprint image or fingerprint image data from the fingerprint sensor. Such fingerprint image data may comprise features extracted from the fingerprint. Authentication module 190 may perform an authentication process by any method for fingerprint authentication known in the art, such as by comparing features extracted from a fingerprint image to a database of fingerprint features associated with an authorized user. Authentication module 190 may perform the authentication process on received raw image data, received filtered or pre-processed image data, or received feature data. Authentication module 190 may also filter or pre-process a received image or image data, and extract features from said image or data.

Controller 406 may be operably connected to fingerprint sensor 152, touch sensor 404, and authentication module 190 in order to control the configuration, power mode, security level, or other aspects of fingerprint sensor 152, touch sensor 404, and authentication module 190. In some implementations, controller 406 may include one or more of a general purpose single- or multi-chip processor, a central processing unit (CPU), a digital signal processor (DSP), an applications processor, an application specific integrated circuit (ASIC), a field programmable gate array (FPGA) or other programmable logic device (PLD), discrete gate or transistor logic, discrete hardware components, or any combination thereof designed to perform the functions and operations described herein.

Fingerprint sensing system 318 may include an image processing module 418. In some implementations, raw measured image data provided by fingerprint sensor 152 may be sent, transmitted, communicated or otherwise provided to image processing module 418. Image processing module 418 may include any suitable combination of hardware, firmware and software configured, adapted or otherwise operable to process the image data provided by fingerprint sensor 152. In some implementations, image processing module 418 may include signal or image processing circuits or circuit components including, for example, amplifiers (such as instrumentation amplifiers or buffer amplifiers), analog or digital mixers or multipliers, switches, analog-to-digital converters (ADCs), passive filters or active analog filters, among others. In some implementations, one or more of such circuits or circuit components may be integrated within controller 406, for example, where controller 406 is implemented as a system-on-chip (SoC) or system-in-package (SIP). In some implementations, one or more of such circuits or circuit components may be integrated within a DSP included within or coupled to controller 406. In some implementations, image processing module 418 may be implemented at least partially via software. For example, one or more functions of, or operations performed by, one or more of the circuits or circuit components just described may instead be performed by one or more software modules executing, for example, in a processing unit of controller 406 (such as in a general-purpose processor or a DSP). In some implementations, image processing module 418 or portions thereof may be implemented in software that may run on an applications processor such as processor 101 associated with mobile device 300 or device 100. The applications processor may have a dedicated coprocessor and/or software modules for secure processing of the biometric image data within the applications processor (sometimes referred to as the “trust zone”).

In some implementations, controller 406 may control fingerprint sensor 152 and image processing module 418, and processor 101 of mobile device 300 may control other components of mobile device 300. In some implementations, processor 101 communicates data to controller 406 including, for example, instructions or commands. In some such implementations, controller 406 may communicate data to processor 101 including, for example, raw or processed image data (also referred to as “image information”) and/or match signals resulting from comparison of fingerprint input data with fingerprint template data. It should also be understood that, in some other implementations, the functionality of controller 406 may be implemented entirely, or at least partially, by processor 101. In some such implementations, a separate controller 406 for fingerprint sensing system 318 may not be required because the functions of controller 406 may be performed by processor 101 of mobile device 101.

Depending on the implementation, one or both of controller 406 and processor 101 may store data in memory 105. For example, the data stored in memory 105 may include raw measured image data, filtered or otherwise processed image data, estimated image data, or final refined image data. Memory 105 may store processor-executable code or other executable computer-readable instructions capable of execution by one or both of controller 406 and processor 101 to perform various operations (or to cause other components such as fingerprint sensor 152, image processing module 418, or other modules to perform operations), including any of the calculations, computations, estimations or other determinations described herein. It should also be understood that memory 105 may collectively refer to one or more memory devices (or “components”). For example, depending on the implementation, controller 406 may have access to and store data in a different memory device than processor 101. In some implementations, one or more of the memory components may be implemented as a NOR- or NAND-based flash memory array. In some other implementations, one or more of the memory components may be implemented as a different type of non-volatile memory. Additionally, in some implementations, one or more of the memory components may include a volatile memory array such as, for example, a type of RAM.

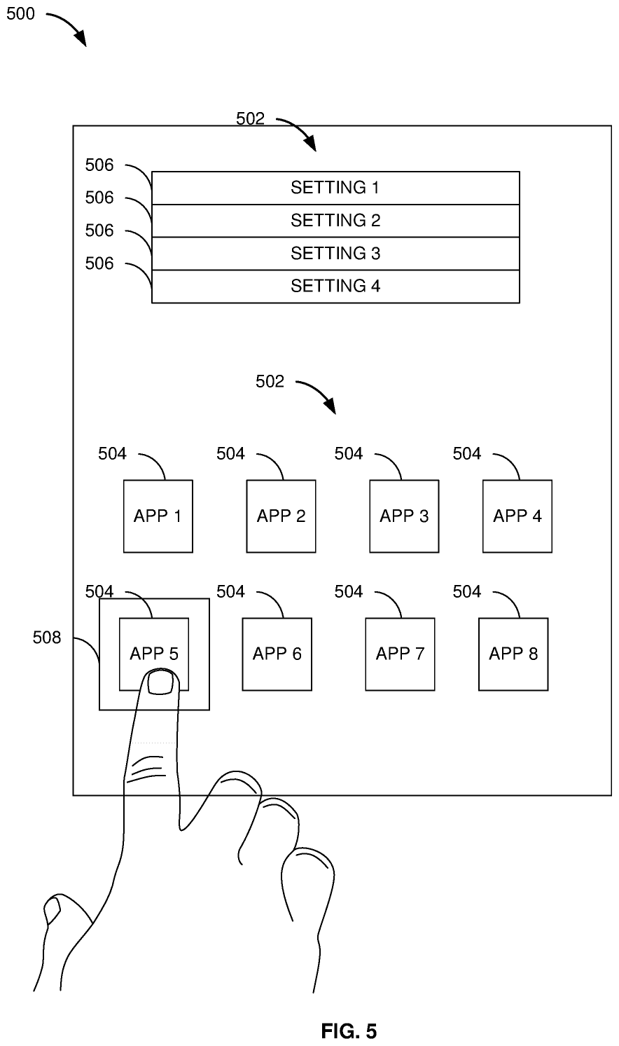

FIG. 5 is a block diagram of an example user interface 500 that may be displayed on display 120 of device 100. In the example shown in FIG. 5, user interface 500 may display a plurality of objects 502 to the user. In one example, objects 502 are icons representative of applications 504 that the user may select. In another example, objects 502 are representative of settings 506 that the user may select to adjust one or more device or application configurations.

In one aspect, one or more objects 502 are secured or “locked” such that the user is unable to access the applications or settings associated with the objects 502 until the user is authenticated. The objects to be locked may be specified by the user. For example, the user may access a lock setting for each application that the user wants to lock. If the user locks an application, then object 502 associated with the application is also locked such that the user cannot select object 502 to launch the application until the user is authenticated.

If the user later wants to access an application that is locked (i.e., in which the associated object 502 is locked), the user may select object 502 using a user input from a finger, stylus, or other input device. Display 120 recognizes the user input and transmits a user input signal to a processor or controller, such as processor 101. Processor 101 determines that object 502 is locked, and then transmits a signal to authentication module 190.

Authentication module 190 may then initiate an authentication process to authenticate the user. In one aspect, authentication module 190 may transmit a signal to camera 170 to capture an image of the user's face to perform a face recognition process such as described above with reference to FIG. 2. In another aspect, authentication module 190 may transmit a signal to fingerprint sensor 152 to capture an image of the user's finger to perform a fingerprint recognition process such as described above with reference to FIG. 4. In other aspects, authentication module 190 may transmit a signal to another biometric authentication system, such as a voice recognition system, a heartbeat recognition system, or the like (none shown).

Authentication module 190 may receive the biometric input from the sensor identified above (e.g., camera 170, fingerprint sensor 152, etc.) and may determine whether the biometric input data matches the biometric template stored during the registration or enrollment process. If authentication module 190 determines that the biometric input data matches the biometric template with a sufficiently high confidence level, authentication module 190 may transmit a match signal to processor 101 or to another suitable processor or controller of device 100. On the other hand, if authentication module 190 determines that the biometric input data does not match the biometric template with a sufficiently high confidence level (i.e., an authentication failure occurs), authentication module 190 may transmit an authentication failure signal to processor 101 or to another suitable processor or controller of device 100, or may transmit no signal in response to the authentication failure. In one example, authentication module 190 may determine that the biometric input data matches the biometric template with a sufficiently high confidence level if a match score or confidence score calculated from comparing the input data with the template is greater than a threshold.

If processor 101 receives the match signal, processor 101 may unlock object 502 such that the user may now gain access to the application or setting represented by object 502. For example, processor 101 may execute or launch the application or may enable the user to change the setting in response to the match signal. However, if processor 101 receives no signal from authentication module or receives an authentication failure signal, processor 101 may continue to prevent the user from accessing the application or setting represented by object 502.

In one embodiment, object 502 may be highlighted or otherwise visually altered to indicate that biometric authentication is in progress for object 502. For example, if the user selects a locked object 502, processor 101 may transmit a signal to display 120 to cause display 120 to display a border 508 around object 502 to indicate that the user has selected the locked object 502 and that the biometric authentication process is in progress. In the example shown in FIG. 5, the user has selected the icon for APP 7, so border 508 is displayed surrounding the selected icon. Border 508 may be a square, a rectangle, a circle, or any other shape that surrounds object 502. Border 508 may also be displayed in a different color than object 502 and the background of user interface 500. In a specific example, border 508 may be a red rectangle surrounding object 502. However, any other suitable border or other visual alteration may be displayed.

In other examples, objects 502 may be associated with applications such as a contacts application or list, a photo gallery application, a game, or any other application.

In some examples, different levels of access may be granted to the user based on the result of the authentication process. For example, in the example of a contact application, if the user is authenticated (i.e., the match signal is generated), the user may gain access to an entire contact list after selecting object 502 associated with the contact application or list. However, if the user is not authenticated (i.e., the match signal is not generated), the user may only gain access to public or non-protected contacts while any protected or private contacts are inaccessible to the user. More generally, a first level of access to an application or setting may be granted to the user if the user is authenticated, while a second, lower, level of access to the application or setting may be granted to the user if the user is not authenticated.

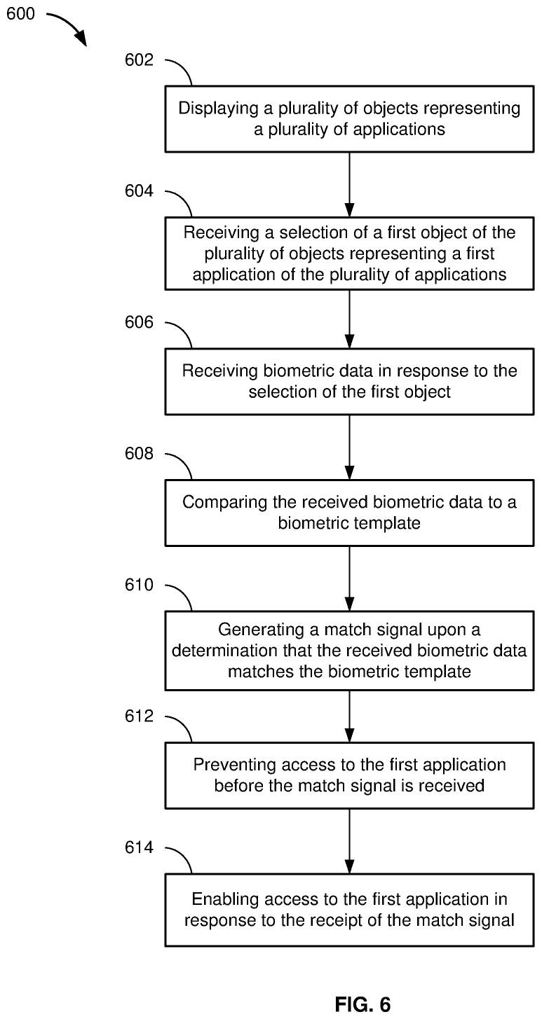

FIG. 6 is a flowchart illustrating an example method 600 of securing access to one or more device applications. In one example, method 600 may be implemented by one or more components of device 100 (shown in FIG. 1) or device 300 (shown in FIG. 3). The following aspects of method 600 will be described based on the implementation of method 600 by device 100 for the sake of simplicity. In some examples, method 600 may be implemented by processor 101 executing the authentication module 190 to perform at least some of the steps of method 600.

At block 602, a plurality of objects representing a plurality of applications are displayed on a display, such as display 120. Accordingly, in some aspects, display 120 is a means for displaying a plurality of objects representing a plurality of application.

At block 604, a selection of a first object of the plurality of objects is received representing a first application of the plurality of applications. In some aspects, display 120 and/or processor 101 are means for receiving a selection of a first object of the plurality of objects representing a first application of the plurality of applications.

At block 606, biometric data is received in response to the selection of the first object. In some aspects, authentication module 190 and/or processor 101 are means for receiving biometric data in response to the selection of the first object.

At block 608, the received biometric data is compared to a biometric template. In some aspects, authentication module 190 and/or processor 101 are means for comparing the received biometric data to a biometric template.

At block 610, a match signal is generated upon a determination that the received biometric data matches the biometric template. In some aspects, authentication module 190 is a means for generating a match signal upon a determination that the received biometric data matches the biometric template.

At block 612, access to the first application is prevented before the match signal is received. In some aspects, processor 101 is a means for preventing access to the first application before the match signal is received.

At block 614, access to the first application is enabled in response to the receipt of the match signal. In some aspects, processor 101 is a means for enabling access to the first application in response to the receipt of the match signal.

As has been previously described, embodiments relate to utilizing methods and procedures implemented by device 100 or device 300 such that device 100 or device 300 may secure access (i.e., prevent access) to applications or settings until a match signal is generated in response to authenticating the user.

It should be appreciated that these are merely examples of the previously described embodiments. It should be appreciated that aspects of the invention previously described may be implemented in conjunction with the execution of instructions by processors of the devices, as previously described. Particularly, circuitry of the devices, including but not limited to processors, may operate under the control of a program, routine, or the execution of instructions to execute methods, modules, or processes in accordance with embodiments of the invention. For example, such a program may be implemented in firmware or software (e.g. stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G New Radio (NR), CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other suitable device. These devices may have different power and data requirements

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
a touch-sensitive display configured to display a plurality of objects representing a plurality of applications, the touch-sensitive display configured to receive a selection of a first object of the plurality of objects representing a first application of the plurality of applications;
an authentication module coupled to the display, the authentication module configured to:
receive biometric data in response to the selection of the first object;
compare the received biometric data to a biometric template; and
generate a match signal upon a determination that the received biometric data matches the biometric template; and
a processor configured to:
prevent access to the first application before the match signal is received; and
enable access to the first application in response to the receipt of the match signal.

2. The apparatus of claim 1, further comprising a camera, wherein the authentication module is configured to receive image data of a user's face for authenticating the user.

3. The apparatus of claim 1, further comprising a fingerprint sensor, wherein the authentication module is configured to receive fingerprint data for authenticating a user.

4. The apparatus of claim 3, wherein the fingerprint sensor is an under-display fingerprint sensor that is configured to receive fingerprint data from a user's touch on the display.

5. The apparatus of claim 1, wherein the plurality of objects representing applications are a plurality of icons which can be selected by touch.

6. The apparatus of claim 5, wherein the first object is a first icon of the plurality of icons, and wherein the processor is further configured to cause the display to display a border surrounding the first icon in response to an initiation of a biometric authentication process caused by the selection of the first object.

7. The apparatus of claim 1, wherein the processor is configured to provide different access levels to a user based on whether the match signal is generated.

8. The apparatus of claim 7, wherein the first application is a contact list application, and wherein the processor is configured to:
enable access to only public contacts in a contact list upon a determination that the match signal has not been generated; and
enable access to both the public contacts and to private contacts in the contact list upon a determination that the match signal has been generated.

9. A method of securing access to device applications, the method comprising:
displaying a plurality of objects representing a plurality of applications;
receiving a selection of a first object of the plurality of objects representing a first application of the plurality of applications;
receiving biometric data in response to the selection of the first object;
comparing the received biometric data to a biometric template;
generating a match signal upon a determination that the received biometric data matches the biometric template;
preventing access to the first application before the match signal is received; and
enabling access to the first application in response to the receipt of the match signal.

10. The method of claim 9, wherein the biometric data includes image data of a user's face from a camera, the method further comprising authenticating the user based on the image data in response to the selection of the first object.

11. The method of claim 9, wherein the biometric data includes fingerprint data of a user's finger from a fingerprint sensor, the method further comprising authenticating the user based on the fingerprint data in response to the selection of the first object.

12. The method of claim 11, wherein the fingerprint sensor is an under-display fingerprint sensor, the method further comprising receiving fingerprint data from the user's touch on the display.

13. The method of claim 9, wherein the plurality of objects representing applications are a plurality of icons which can be selected by touch, the first object is a first icon of the plurality of icons, and wherein the method further comprises displaying a border surrounding the first icon in response to an initiation of a biometric authentication process caused by the selection of the first object.

14. The method of claim 9, further comprising providing different access levels to the user based on whether the match signal is generated.

15. The method of claim 14, wherein the first application is a contact list application, the method further comprising:
enabling access to only public contacts in a contact list upon a determination that the match signal has not been generated; and
enabling access to both the public contacts and to private contacts in the contact list upon a determination that the match signal has been generated.

16. An apparatus, comprising:
means for displaying a plurality of objects representing a plurality of applications, the means for displaying configured to receive a selection of a first object of the plurality of objects representing a first application of the plurality of applications;
means for receiving biometric data in response to the selection of the first object;
means for comparing the received biometric data to a biometric template;
means for generating a match signal upon a determination that the received biometric data matches the biometric template;
means for preventing access to the first application before the match signal is received; and
means for enabling access to the first application in response to the receipt of the match signal.

17. The apparatus of claim 16, further comprising a means for generating image data of a user's face, wherein the means for receiving biometric data is configured to receive image data of the user's face for authenticating the user.

18. The apparatus of claim 16, further comprising a means for generating fingerprint data of a user's finger, wherein the means for receiving biometric data is configured to receive fingerprint data for authenticating the user.

19. The apparatus of claim 16, wherein the plurality of objects representing applications are a plurality of icons which can be selected by touch.

20. The apparatus of claim 19, wherein the first object is a first icon of the plurality of icons, and wherein the means for displaying is further configured to display a border surrounding the first icon in response to an initiation of a biometric authentication process caused by the selection of the first object.

21. The apparatus of claim 16, wherein the means for preventing access to the first application is configured to provide different access levels to a user based on whether the match signal is generated.

22. The apparatus of claim 21, wherein the first application is a contact list application, and wherein the means for enabling access to the first application is configured to:
enable access to only public contacts in a contact list upon a determination that the match signal has not been generated; and
enable access to both the public contacts and to private contacts in the contact list upon a determination that the match signal has been generated.

23. A non-transitory storage medium comprising processor-executable instructions stored thereon, wherein, when a processor executes the instructions, the processor is configured to:
display a plurality of objects representing a plurality of applications;
receive a selection of a first object of the plurality of objects representing a first application of the plurality of applications;
receive biometric data in response to the selection of the first object;
compare the received biometric data to a biometric template;
generate a match signal upon a determination that the received biometric data matches the biometric template;
prevent access to the first application before the match signal is received; and
enable access to the first application in response to the receipt of the match signal.
